(19) United States
(12) Patent Application Publication
(10) Pub. No.: US 2025/0176538 A1
(43) Pub. Date: Jun. 5, 2025

(54) WATER-DISPERSIBLE GRANULAR COMPOSITION AND PROCESS FOR PREPARING SAME

(71) Applicant: DVA AGRO GMBH, Hamburgo (DE)

(72) Inventors: Natália GONÇALVES, Indaiatuba, São Paulo (BR); João Paulo ALEIXO, Hamburgo (DE); Rafaela Cristina FEITOSA CORSI, Santa Barbara d'Oeste, São Paulo (BR); Joseph Alberto HERNÁNDEZ NAVARRO, Buenos Aires (AR)

(21) Appl. No.: 18/832,387

(22) PCT Filed: Feb. 6, 2023
(86) PCT No.: PCT/BR2023/050038

§ 371 Date: Jul. 23, 2024

(30) Foreign Application Priority Data
Feb. 11, 2022 (BR) 1020220026548
Feb. 2, 2023 (BR) 1020230020119

(51) Int. Cl. A01N 25/14; A01N 37/34; A01N 43/38; A01P 17/00

(52) U.S. Cl. CPC A01N 25/14; A01N 37/34; A01N 43/38; A01P 17/00

(57) ABSTRACT

A novel composition of water-dispersible granules (WG), having at least one compound selected from the group of dinitriles or phthalamides, at least one compound selected from the group of strobilurins, at least one compound selected from the group of azoles, and at least one carrier for use in the field. In addition, a process for preparing the WG composition, as well as its use as an agricultural pesticide. Finally, a process also for controlling the growth of agricultural pests.

### FIELD OF THE INVENTION

The present invention relates to a novel composition of water-dispersible granules (WG) comprising at least two agrochemically active substances in solid form, preferably in solid powder form. Additionally, the present invention relates to a process for preparing the WG composition, as well as its use as an agricultural pesticide. Finally, the present invention relates to a process for controlling the growth of agricultural pests.

### BACKGROUNDS OF THE INVENTION

Agribusiness represents an important sector for the economy of several countries, such as Brazil and the United States. Notwithstanding, this field faces several problems related to its production, especially due to resistance to current agricultural pesticides acquired by weeds, pests and other undesirable plants.

Agricultural plant pests cause significant damage to crops, compromising both their quantity and quality. It is important to highlight that modern agriculture still relies heavily on fungicides to ensure high yields and product quality.

In this sense, there is a growing search to control the number of pests, in order to prevent interference with cultivated plants from causing negative impacts on economic production (PATEL, 2018).

The production costs of cultivated plants, associated with the presence of pests that gain resistance to current agricultural pesticides, have been increasing every year. For this reason, anti-resistance strategies are widely used in the field, in order to reduce losses. The use of agricultural pesticides with different mechanisms of action (applied in combination or alone) and strategies for using them stand out among such strategies (GEMELLI et al., 2012).

Specifically, azoles have been the most widely used class of fungicides to control fungal diseases in recent decades. In the field, it is recognized that azole compounds provide long-lasting control of many agricultural pests of target plants and are classified as having moderate risk of developing fungicide resistance. Therefore, the compounds from the group of azoles are still considered extremely important for many control strategies and widely used as soil fungicides or as mixing partners with other groups of fungicides, expanding the control spectrum and minimizing the general risk of resistance development (JORGENSEN and HEICK, 2021).

In addition to the azole compounds, chlorothalonil stands out as one of the most used fungicides around the world and in Brazil. This compound is mainly applied to fruits and vegetables, but also against fungal diseases in soybeans (GOTTEMS, 2018).

Furthermore, compounds with a broad spectrum of fungicidal, insecticidal or herbicide action gain prominence in the field, as they are capable of preventing, reducing or eliminating a greater number of diseases, insects or undesirable plants. Strobilurins are included in this type of compounds. In addition to this versatility, sometimes unexpected positive effects are attributed to these compounds, as is the case of cereals treated with pyraclostrobin, which showed a significant increase in productivity, in addition to those expected due to its fungicidal effect (PINTO, 2019).

It is no surprise that the combination of these surprising compounds would result in a composition with even more positive effects. The combination of agricultural pesticides, adjuvants and other action-enhancing compounds is common for the agrochemical sector, capable of increasing the effects of agricultural pesticides, improving control efficiency with fewer applications, among other benefits that can reduce operational costs and losses of harvest (VIECELLI, M, et al., 2019).

Therefore, the agrochemical sector constantly proposes new combinations between adjuvants, agricultural pesticides and other agrochemical compounds, to overcome the deficiencies associated with the use of the agricultural pesticides alone or inefficient combinations.

In addition to anti-resistance strategies, other factors can influence the success of the composition, as is the case of preparations in the form of water-dispersible granules (WG), which present advantages related to ease of use, storage and packaging, absence of dust and non-biodegradable, flammable, volatile or minimally toxic solvents. Said qualities are not observed in most other forms known in the field of application of the invention (i.e., SCs, ECs, WPs, SLs, among others).

WG compositions can be prepared by various techniques, such as extrusion, spray granulation and tank granulation. However, as broadly described in PI1007854-1, for each group of pesticides and/or form in which such pesticides are found, it may be necessary to develop a specific process for producing the WG composition. Ideal processes for one type of formulation can generate compositions with low dispersion, little stability, low storage life and different undesirable properties for other WG.

Therefore, it remains clear that additional experiments need to be carried out to establish suitable processes for producing a composition of water-dispersible granules comprising at least one compound selected from the group of dinitriles or phthalamides, at least one compound selected from the group of strobilurins and at least one compound selected from the group of azoles.

The present invention improves the soil, as it is capable of reducing the necessary quantity of pesticides in the field, consequently reducing contamination of the soil, groundwater, rivers, among other environments that have come into contact with such agricultural pesticides.

### SUMMARY OF THE INVENTION

The present invention relates to a composition of water-dispersible granules comprising at least one compound selected from the group of dinitriles or phthalamides, at least one compound selected from the group of azoles, and optionally at least one compound selected from the group of strobilurins, their salts or N-oxides.

Furthermore, the present invention refers to a new process for preparing said composition of water-dispersible granules, which is capable of reducing the degradation effect of agricultural pesticide compounds.

Additionally, the present invention relates to a process for controlling agricultural pests, such as rust, Plasmopara viticola, Elsinoe ampelina, Phomopsis viticola, Glomerella cingulata, Melanconium fuligineum, Isariopsis clavispora, Fusarium oxysporum f.sp. herbemontis and other agricultural pests, especially in soybean, sorghum, cotton, rice, wheat, corn and oat crops.

In addition, the present invention involves the use of said composition as a fungicide.

The invention described herein achieves better results in the production yield of crop plants, as it combats acquired resistance to state-of-the-art pesticides, as well as enhancing the pesticide effects of these agricultural pesticides.

### DESCRIPTION OF FIGURES

FIG. 1—Chromatogram of the primary standard of Chlorothalonil Pestanal.

FIG. 2—Chromatogram of the primary standard of Picoxystrobin Pestanal.

FIG. 3—Chromatogram of the primary standard of Prothioconazole Pestanal.

FIG. 4—Chromatogram of the secondary standards of Chlorothalonil, Picoxystrobin and Prothioconazole.

FIG. 5—Chromatogram of the sample prepared in laboratory containing Chlorothalonil, Picoxystrobin and Prothioconazole.

### DETAILED DESCRIPTION OF THE INVENTION

The present invention relates to a composition of water-dispersible granules comprising at least one compound selected from the group of dinitriles or phthalamides, at least one compound selected from the group of azoles, and optionally at least one compound selected from the group of strobilurins, their salts or N-oxides.

Said compound selected from the group of dinitriles or phthalamides is preferably chlorothalonil, captan, folpet, mixtures thereof, their salts or their N-oxides. These compounds are present in a range of 45% to 75% of the total weight of the composition.

Said compound selected from the group of azoles is prothioconazole, cyproconazole, tebuconazole, propiconazole, difenoconazole, hexaconazole, penconazole, ipconazole, metconazole, epoxiconazole, azaconazole, bitertanol, bromuconazole, diclobutrazol, difenoconazole, diniconazole, etaconazole, fenbuconazole, fluquinconazole, flusilazole, flutriafol, imibenconazole, myclobutanol, paclobutrazol, penconazole, simeconazole, tetraconazole, tridimefon, tridimenol and triticonazole, their mixtures, their salts or their N-oxides. These compounds are present in a range of 0.5% to 7.5% of the total weight of the composition.

Said compound selected from the group of strobilurins is preferably picoxystrobin, pyraclostrobin, azoxystrobin, trifloxystrobin, dimoxystrobin, famoxadone, fenamidone, fluoxastrobin, cresoxim-methyl, metaminostrobin, their mixtures, their salts or their N-oxides. These compounds are present in a range of 0.5% to 5% of the total weight of the composition.

The compounds described herein are in their solid form, preferably in solid powder form.

In one embodiment, the composition of the present invention can be combined with at least one additional agricultural pesticide, depending on the crop to which this composition will be applied. Said additional compound is preferably mancozeb, cupric fungicides, benomyl, methyl thiophanate, captafol, triphenyltin acetate, carbendazim, thiabendazole, copper oxychloride, copper sulfate and triphenyltin hydroxide, mixtures thereof, their salts or N-oxides.

The amount of additional pesticide in the composition or to be applied in the field will depend on the type of compound to be used and its manufacturer. Said quantities are known in the state of the art, especially because the compounds mentioned herein are widely used in the field of this invention. Each additional compound of the state of the art is accompanied by a leaflet, which will indicate the appropriate dosage for application in the field. That being said, the quantities mentioned herein are not intended to limit the present invention, but only to better define the matter that is object of protection.

Optionally, the composition of the present invention further comprises adjuvants or other compounds capable of improving a specific property of the composition or its compounds, such as, for example, its solubility or pesticidal effect.

Said adjuvants or other compounds capable of improving a specific property of the composition comprise phosphoric acid ethoxylated alkyl ester compounds, methyl esters or fatty acid methyl esters, metal complexes, complexes of inorganic or organic compounds, aromatic hydrocarbons, unsaturated or saturated fatty acids, one or more basic compounds, one or more acids, solvents, salts, macro or micronutrients, diluents, organic or inorganic solids, antifoam agents, preservative agents, antioxidant agents, carrier agents, wetting agents, dispersing agents, solid carriers, suspending or anti-sedimentation agents, absorption or adsorption aids, adhesive agents, surfactant agents, disintegrating agents, stabilizers, antifreezers, polymers or copolymers, mineral, vegetable, organosilicon oils, soluble or insoluble in water, organic or inorganic, or mixtures thereof, and any other components present in formulations of the state of the art and widely used in the field of application of the invention.

Said additional compounds are present in a concentration of 5 to 50% of the total weight of the composition.

Particularly, the composition additionally comprises at least one carrier agent, at least one wetting agent, at least one dispersing agent and at least one disintegrating agent.

The composition preferably comprises 5% to 30% of at least one carrier agent, 0.5 to 2.5% of at least one wetting agent, 2 to 5% of at least one dispersing agent, and 0.25 to 1.5% of at least one disintegrating agent.

Preferably, at least one carrier agent is selected from the group comprising silica and silicates, in particular, kaolin, diatomaceous earth, bentonite, attapulgite, perlite, their derivatives and mixtures thereof.

Preferably, at least one wetting agent is selected from the group comprising naphthalene sulfonates, alkyl aryl or alkyl benzene sulfonates, sulfosuccinates, sulfated esters, phosphate esters and sulfated alcohol, their derivatives and mixtures thereof.

Preferably, at least one dispersing agent is selected from the group comprising naphthalene sulfonate condensates, lignosulfonate, polycarboxylate, phenol sulfonic acid condensates, methyl oleyl taurates, polyvinyl alcohols, their derivatives and their mixtures.

Preferably, at least one disintegrating agent is selected from the group comprising croscarmellose, starches, clays, cellulose, crospovidone, sodium starch glycolate, their derivatives and mixtures thereof.

Optionally, within the modalities described above, the composition described herein may be in the form of “ready mix” or “in can” formulations.

The composition of the present invention is in the form of a water-dispersible granule, commonly known as a WG formulation.

The composition must be in the form that best suits the particular intended objective and the physical, chemical and biological properties of the composition, such as, for example, its solubility or pesticide effect. The technician skilled on the subject will be able to select the best way to be applied to the field, since its preparation is part of the state of the art.

Surprisingly, it was discovered that the processes of the state of the art, for preparing a WG composition comprising at least one compound selected from the group of dinitriles or phthalamides and at least one compound selected from the group of azoles, were not suitable.

The presence of a compound selected from the group of dinitriles or phthalamides causes the degradation of the compound selected from the group of azoles. In this sense, an innovative process for preparing the composition of this invention is described below.

The present invention refers to a process for preparing the composition as described herein, which comprises the steps of:
a1. reducing to a size of D₉₀ between 1 and 25 μm the particles of at least one compound selected from the group of dinitriles or phthalamides, their salts or N-oxides;
a2. separately reducing to a size of D₉₀ between 1 and 25 μm the particles of at least one compound selected from the group of azoles, their salts or N-oxides;
b. optionally drying the particles from steps a.1 and a.2 to a moisture content of not less than 2%;
c. aggregating by statics the particles of a.2 to the surface of the particles of a.1.

The particle size reduction steps can occur using dry or wet methodologies known in the state of the art, such as, for example, dry granulation methodologies by disaggregation, wet granulation methodologies by aggregation, or any other methodology capable of reducing particle size up to D₉₀ between 1 and 25 μm.

The methodology used in the particle reduction step needs to be capable of reaching a particle size of D₉₀ between 1 and 25 μm, so that the particle from step a.2 can aggregate to the surface of particle from step a.1. Sizes smaller or larger than 1 to 25 μm do not allow aggregation by statics of these particles, which results in the degradation of azole compounds, due to contact with dinitrile or phthalamide compounds.

The particle reduction processes can be, but should not be limited to fluidized bed granulation, high-shear granulation, rotary drum or disc granulation, ball mill, or any other equipment capable of reducing particle size. The particle size reduction steps must occur separately to avoid absorption of the particles of azoles by the particles of dinitrile or phthalamide.

The particles from steps a.1 and a.2 can go through the drying step separately or together, depending on the used drying method. Drying may be carried out by any method known in the state of the art, hot air drying, drying by direct contact with a hot surface, radiation drying and freeze drying, spray drying, provided that this method dries the particles to a moisture content of no less than 2%. Preferably, the moisture of said particles will be between 2% and 50%.

The particles of at least one compound selected from the group of azoles can be aggregated to the surface of the particles of at least one compound selected from the group of dinitriles or phthalamides by any method known in the state of the art, for example, but not limited to a spray method.

Optionally, the particles of at least one compound selected from the group of strobilurins, their salts or N-oxides will be reduced to a size of D₉₀ between 1 and 25 μm also in step a.1, together with at least a compound selected from the group of dinitriles or phthalamides, their salts or N-oxides.

Particularly, the present invention refers to a process for preparing the composition as described herein, which comprises the steps of:
a. adding at least one compound selected from the group of dinitriles or phthalamides, their salts and N-oxides, in solid form;
b. adding at least one dispersing agent, at least one wetting agent, at least one disintegrating agent and at least one carrier agent in solid form;
c.1. reducing particle size from step b. up to D₉₀ between 1 and 25 μm;
c.2. reducing the particle size of at least one compound selected from the group of azoles up to D₉₀ between 1 and 25 μm;
d. extruding and drying the mixture to a moisture content of not less than 2%;
e. aggregating by statics to the surface of the mixture from step d. at least one compound selected from the group of azoles from step c2.

During steps a. and b., the addition can be carried out in a mixer of the state of the art, such as, for example, in a batch or continuous type mixer, Y, V, horizontal, ribbon mixers, or any other type of equipment suitable for mixing solid components, especially in powder form.

Steps a. to c1. they may occur separately or concomitantly, depending on the equipment used. For example, the ribbon mixer is a piece of equipment capable of mixing and granulating the particles of the composition. On the other hand, step c1. may occur separately from steps a. and b., as is the case with reduction in an air jet crusher, wherein the particles are reduced only after being mixed and homogenized.

Specifically, steps c1. and c2. occur separately, and their reductions can occur in equipment with the same reduction mechanism or with different reduction mechanisms.

After step c1, optionally, the mixture can be wetted with 5% to 25% water, in order to facilitate the extrusion process.

Step d. of extrusion and drying can be carried out in any equipment of the state of the art capable of carrying out such operations, such as, for example, but not limited to high or low pressure extruder, spraying, compaction, granulation by rotary drum or disc, or any other equipment capable of carrying out the aforementioned operations.

Before step e. of aggregation by statics, it is necessary that all particles have a size of D₉₀ between 1 and 25 μm, because, if these components are in their liquid forms (for example, as EC or SC compositions) or in smaller or larger sizes, at least one dinitrile or phthalamide compound will degrade at least one azole compound.

The process of preparing the composition of the present invention allows the azole compound to adhere to the water-dispersible granule by means of statics on the surface of the granules.

Optionally, the particles of at least one compound selected from the group of strobilurins, their salts or N-oxides will be added in step a., together with at least one compound selected from the group of dinitriles or phthalamides, their salts or N-oxides.

Additionally, the present invention relates to a process for controlling the unwanted growth of agricultural pests, such as rust, Plasmopara viticola, Elsinoe ampelina, Phomopsis viticola, Glomerella cingulata, Melanconium fuligineum, Isariopsis clavispora, Fusarium oxysporum f.sp. herbemontis and other agricultural pests, especially in soybean, sorghum, cotton, rice, wheat, corn, oats crops, but also berries (such as banana, coffee, apple, papaya, watermelon, melon, mango and grape), fruits (such as pumpkin, zucchini, tomatoes, chayote, gherkin, peppers and cucumber), leaf vegetables (such as lettuce, Chinese cabbage and Brussels sprouts), legumes (such as peanuts, peas, beans, chickpeas and lentils), vegetables (such as eggplant, broccoli, cabbage, kale and cauliflower), cereals (such as rye, barley and triticale), tubers (such as English potatoes, baroa potatoes, yacon potatoes, radishes and manioc), roots (such as beets, sweet potato, carrot, cassava, yam, ginger and turnip), bulbs (such as onion and garlic), ornamental plants (such as anthurium, azalea, begonia, bromeliad, chrysanthemum, gerbera, hydrangea, forget-me-not, orchid, rose, tulip and sunflower), trees (such as rubber trees), and grasses (such as millet and sugar cane), or any other crop that is affected by such undesirable pests, through the application of the composition of this invention to the plant and/or its habitat.

Controlling the unwanted growth of agricultural pests includes preventing, killing, reducing or delaying their growth.

The application rates of the combination may vary depending on several factors, which are widely known in the field of application of this invention, such as, for example, the nature of the soil, the application method (post-emergence; foliar treatment; treatment of seeds; application in the seed furrow; etc.), the crop plant, the undesirable agricultural pests to be controlled, the climatic conditions at the time of application and other factors.

The application in the field can be carried out by spraying the combination, sprinkling, dripping or watering, depending on the structure that the applicator presents, as well as the form of the combination.

Furthermore, the present invention relates to the use of this composition as a fungicidal composition, to eliminate or reduce the unwanted growth of agricultural pests on plants and/or their habitat.

The examples described herein are not intended to limit the scope of this invention, but are intended to prove that additional experiments needed to be developed to achieve the correct production process of the composition claimed herein.

### Example 1

To prepare a first WG composition, Armid DM10 or DM810 were added to a mixer at a concentration of 45% w/w, followed by the addition, under stirring, of 35% w/w of 98.4% prothioconazole, and finally the inclusion of the surfactants ethoxylated Tristyrylphenol (16EO) and ethoxylated castor oil (40EO), in concentrations of 16% and 4% w/w, respectively. Subsequently, silica was adsorbed to obtain 63% Prothioconazole 35% EC and 37% silica. Said powder was reserved.

In a different mixer, chlorothalonil, picoxystrobin, dispersing agents, wetting agents and kaolin were added, all in powder form. Next, the prothioconazole adsorbed silica pre-formulated as EC was inserted into this second mixer. After proper homogenization of the mixture, the solid was ground in air flow until D₉₀<10 μm. Next, the powder obtained in the previous step was wetted with 10% water and SAG 1572, extruded and dried until reaching a moisture of no less than 2% (Table 1).

TABLE 1
Components of the first WG composition

| | Concentration |
|---|---|
| Components | (% by weight) |
| 98.5% Chlorothalonil | 60.91 |
| 35% Prothioconazole EC + 37% Silica | 19.4 |
| 97% Picoxystrobin | 3.43 |
| Morwet D 425 | 5.00 |
| Morwet EFW | 2.00 |
| Kaolin | 9.12 |
| SAG 1572 | 0.50 |

### Example 2

To prepare a second WG composition, the active ingredients chlorothalonil and picoxystrobin, the dispersing and wetting agents, kaolin and silica, all in powder form, were added to a mixer. This solid composition, after proper homogenization, went through the grinding process in air flow until D₉₀<10 μm. Before the wetting step, the 35% Prothioconazole EC composition was added to the ground composition. Next, said powder was wetted with 6% water and SAG 1572; subsequently, the mixture was extruded and dried until it reached a moisture of no less than 2% (Table 2).

TABLE 2
Components of the second WG composition

| | Concentration |
|---|---|
| Components | (% by weight) |
| 98.5% Chlorothalonil | 60.91 |
| 35% Prothioconazole EC | 12 |
| 97% Picoxystrobin | 3.43 |
| Morwet D 425 | 5.00 |
| Morwet EFW | 2.00 |
| Kaolin | 14.16 |
| SAG 1572 | 0.50 |

### Example 3

To prepare a third WG composition, the active ingredients chlorothalonil and picoxystrobin, the dispersing, wetting and disintegrating agents, kaolin and silica, all in powder form, were added to a mixer. This solid composition, after its due homogenization, went through the grinding process in air flow until D₉₀<10 μm. Then, said powder was wetted with 20.6% water containing 2% PVP and 2% SAG 1572. Subsequently, the mixture was extruded and dried until reaching a moisture of not less than 2%. After the granule was dry, prothioconazole, already ground to D₉₀<10 μm, was added, in order to adhere by statics to the surface of the granules (Table 3).

TABLE 3
Components of the third WG composition

| | Concentration |
|---|---|
| Components | (% by weight) |
| 98.5% Chlorothalonil | 60.905 |
| 98.4% Prothioconazole | 4.200 |
| 97% Picoxystrobin | 3.430 |
| Morwet D 425 | 5.000 |
| Morwet EFW | 2.000 |
| Kaolin | 22.958 |
| Silica | 0.500 |
| Croscarmellose | 1.000 |
| PVP | 0.004 |
| SAG 1572 | 0.004 |

### Example 4

The state of degradation of the active ingredients of the compositions of EXAMPLES 1 to 3 was analyzed, in accordance with that established by CIPAC MT 46.3, and after the concentration had been analyzed in HPLC.

### Mobile Phase

The analytical method comprises the steps of preparing the mobile phase, wherein 0.7 mL of phosphoric acid was added to a flask 1 in 1000 mL of HPLC purity grade water, and after stirring, the electrode was inserted into the aqueous solution and the pH was adjusted to 2.0 with phosphoric acid. This system, after homogenization, was vacuum filtered and stored in a glass bottle with a lid for a maximum of 3 days. Next, in a flask 2, filtered and degassed HPLC grade acetonitrile was inserted. Meanwhile, a flask 3 contained filtered and degassed HPLC grade methanol. In a system with a quaternary pump, the mobile phase is obtained from mixing flasks 1, 2 and 3, as follows: Acetonitrile:Methanol:Aqueous dissolution of H₃PO₄ at pH 2.0, filtered and degassed, in proportion 35:35:30. The Zorbax Eclipse XDB C-18 5 μm (4.6×250 mm) chromatographic column was stabilized with this mobile phase for 40 minutes before starting the analysis.

### Primary Standard Solution of Chlorothalonil Pestanal, 99.7% w/w Concentration

To prepare the solution with a concentration of 3.00 mg of chlorothalonil/mL, 75 mg±5 mg of the primary standard were weighed into a 25 mL volumetric flask. Next, 10 mL of acetonitrile was added, which was dissolved by sonication. After reaching room temperature, the flask was filled with the solvent. Said solution is to be prepared in duplicate.

### Primary Standard Solution of Picoxystrobin Pestanal, 99.8% w/w

To prepare the solution with a concentration of 0.17 mg of picoxystrobin/ml, 67 mg±5 mg of the primary standard were weighed in a 100 mL volumetric flask. Then, acetonitrile was inserted into the flask until the flask mark was reached, which was dissolved by sonication. After reaching room temperature, 5 mL of the solution were removed and completed with solvent until reaching 20 mL.

### Primary Standard Solution of Prothioconazole Pestanal, 99.6% w/w Concentration

To prepare the solution with a concentration of 0.21 mg of prothioconazole/mL, 84 mg±5 mg of primary standard were weighed in a 100 mL volumetric flask. Next, acetonitrile was inserted into the flask until the flask mark was reached, which was dissolved by sonication. After reaching room temperature, 5 mL of the solution were removed and completed with solvent until reaching 20 mL.

### Secondary Standard Solution of Technical Chlorothalonil, Picoxystrobin, Prothioconazole—98% w/w Purity

In flask A, 3306±5 mg of technical grade chlorothalonil were weighed into a 100 mL volumetric flask with 30 mL of acetonitrile. In 100 mL flask B, 69±5 mg of picoxystrobin and 85±5 mg of prothioconazole, both technical grades, were weighed, which was completed with acetonitrile, and left to rest in a sonicator at 30° C. for 10 min. Next, after the flask reached room temperature, a 25 mL aliquot from Flask B was removed and added to Flask A, the latter of which was filled with acetonitrile up to the mark, and again inserted into the sonicator at 30° C. for 10 min. The concentration of the analytes in Flask A was 3.00 mg/mL of Chlorothalonil, 0.17 mg/mL of Picoxystrobin and 0.21 mg/mL of Prothioconazole.

### Solution Prepared in the Laboratory of 60.0% w/w Chlorothalonil+3.33% w/w Picoxystrobin+4.13% w/w Prothioconazole

Initially, it is necessary to grind each of the solid analytes in a mortar with a hammer until homogenized to obtain the sample. The samples were weighed, inserted into a flask, and acetonitrile was included until the concentration of the analytes reached 3.00 mg/mL of chlorothalonil, 0.17 mg/mL of picoxystrobin and 0.21 mg/mL of prothioconazole.

### Analysis of Standard Solutions

For the analysis of the standard solutions discussed above, 0.45 μm of each solution was filtered, which were injected in duplicate. In this way, the average areas obtained for each active ingredient or analytes were obtained. The relative standard deviation between duplicates of the same standard solution was established to be less than 2.0%. The deviation is calculated as follows:

$$s = \sqrt[2]{\frac{1}{( n - 1 )} {\sum }_{i = 1}^{n} {( {x}_{i} - \overline{x} )}^{2}} DSR = \frac{s}{\overline{x}} \times 100$$

s: Standard deviation.
DSR: Relative standard deviation.
n: Total number of injections.
xᵢ: Area.
x⁻: Average of the areas.

For each standard solution, the response factor (FR) per active ingredient was calculated. At the same time, the average response factor between the two standard solutions per active ingredient was also calculated:

FR=Average area/Sample concentration

$${FR}_{average} ( Standard Sc ) = \frac{FR ( Standard Sc 1 ) + FR ( Standard Sc 2 )}{2}$$

The relative standard deviation between the response factors of both standard solutions must be less than 2.0%.

### Sample Analysis

For sample analysis, 0.45 μm of this sample was filtered and each injected in duplicate. The Relative Standard Deviation between the areas of each analyte (chlorothalonil, picoxystrobin or prothioconazole) in the same sample solution was established as less than 2.0%. Subsequently, the FR_{average} of each sample solution per analyte was calculated, the average of each FR_{average} of both solutions was established, and finally the content of each active ingredient was determined as follows:

$$Analyte ( \% w / w ) = \frac{F {R}_{a v erage} of the sample \times Concentration of the standard}{F {R}_{a v e r a g e} of the standard solution}$$

To obtain the concentration in % w/v, the % w/w value was multiplied by the density, in units of g/mL.

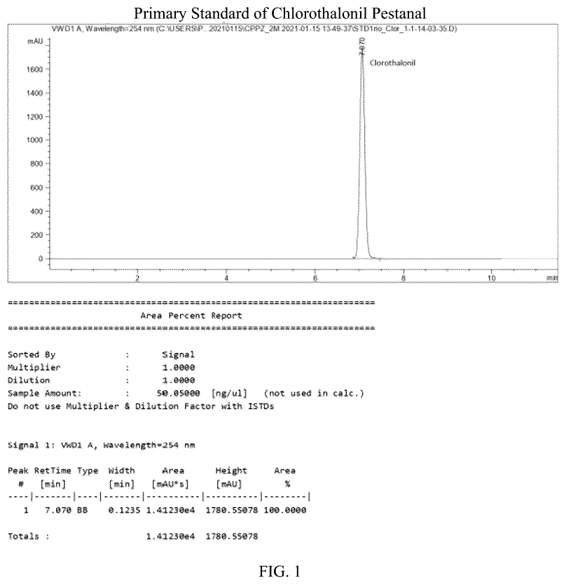

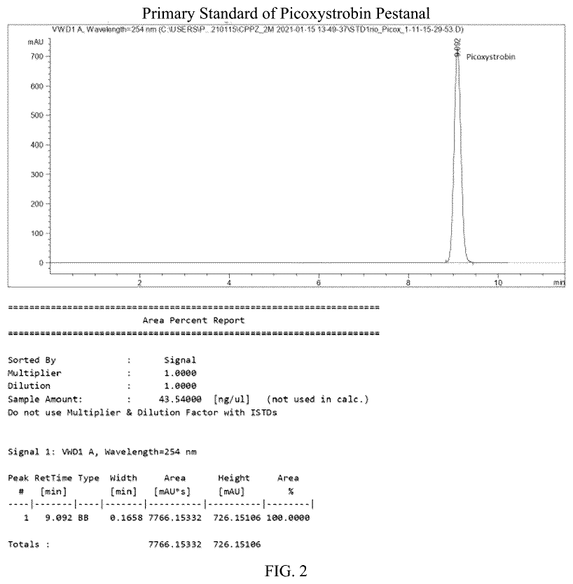

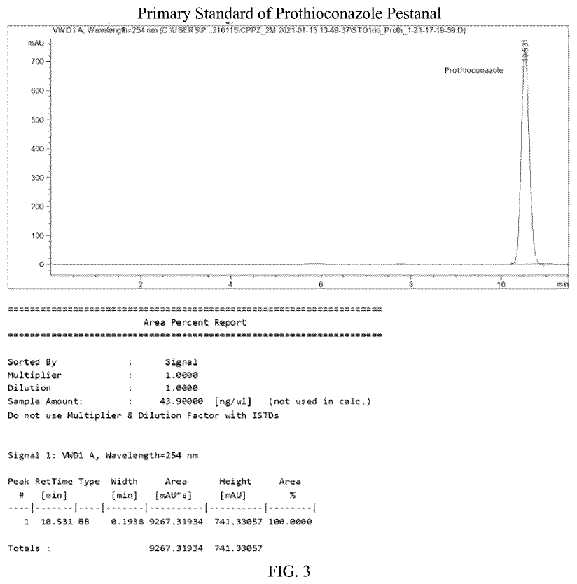

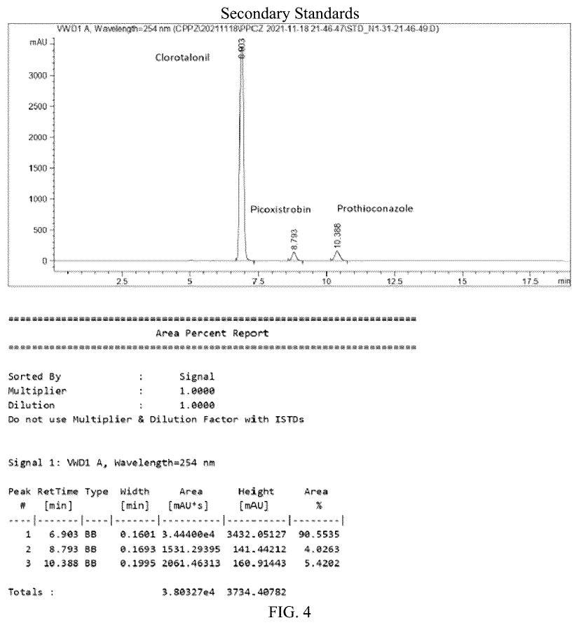

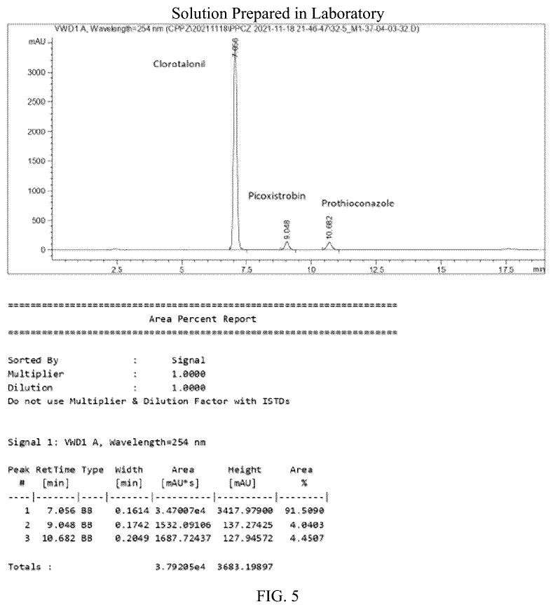

As seen in FIGS. 1 to 5, and summarized in Table 4, only the composition prepared according to EXAMPLE 3 did not show degradation greater than 5% for the active ingredient prothioconazole:

TABLE 4
State of degradation of active ingredients

| Active | | | | | | |
|---|---|---|---|---|---|---|
| ingredient | EXAMPLE 1 | | EXAMPLE 2 | | EXAMPLE 3 | |
| (% w/w) | Initial | Final | Initial | Final | Initial | Final |
| Chlorothalonil | 42.84 | 42.85 | 42.55 | 42.91 | 59.96 | 60.01 |
| % Degradation at | 0 | | 0 | | −0.08 | |
| 54° C. after 14 | | | | | | |
| days | | | | | | |
| Picoxystrobin | 3.42 | 3.26 | 3.36 | 3.28 | 3.6 | 3.58 |
| % Degradation at | 4.68 | | 2.38 | | 0.56 | |
| 54° C. after 14 | | | | | | |
| days | | | | | | |
| Prothioconazole | 3.04 | 1.87 | 3.10 | 1.82 | 4.16 | 4.04 |
| % Degradation at | 38.49 | | 41.29 | | 2.88 | |
| 54° C. after 14 | | | | | | |
| days | | | | | | |

As clearly observed, other production processes for this specific composition did not obtain satisfactory degradation results, since prothioconazole showed degradation well above 5. On the other hand, the production process disclosed in EXAMPLE 3 achieved much better results (that is, at least 10 times less degradation).

1. A composition of water-dispersible granules comprising:
45% to 75% of the total weight of the composition comprising at least one compound selected from a group of dinitriles or phthalamides,
0.5% to 7.5% of the total weight of the composition comprising at least one compound selected from a group of azoles, and
optionally 0.5% to 5% of the total weight of the composition comprising at least one compound selected from a group of strobilurins, their salts or their N-oxides,
wherein said at least one compound of the group of azoles is selected from the groups consisting of prothioconazole, cyproconazole, tebuconazole, propiconazole, difenoconazole, hexaconazole, penconazole, ipconazole, metconazole, epoxiconazole, azaconazole, bitertanol, bromuconazole, diclobutrazol, difenoconazole, diniconazole, etaconazole, fenbuconazole, fluquinconazole, flusilazole, flutriafol, imibenconazole, myclobutanol, paclobutrazol, penconazole, simeconazole, tetraconazole, tridimefon, tridimenol, triticonazole, mixtures thereof, their salts and their N-oxides.

2. The composition according to claim 1, wherein said compound selected from the group of dinitriles or phthalamides is selected from the group consisting of chlorothalonil, captan, folpet, mixtures thereof, their salts and their N-oxides.

3. The composition according to claim 1, wherein said compound selected from the group of strobilurins is selected from the group consisting of picoxystrobin, pyraclostrobin, azoxystrobin, trifloxystrobin, dimoxystrobin, famoxadone, fenamidone, fluoxastrobin, cresoxim-methyl, metaminostrobin, their mixtures, their salts and their N-oxides.

4. The composition according to claim 1, wherein the compounds are in solid powder form.

5. The composition according to claim 1, further comprising at least one additional compound selected from the group consisting of mancozeb, cupric fungicides, benomyl, methyl thiophanate, captafol, triphenyl tin acetate, carbendazim, thiabendazole, copper oxychloride, copper sulfate and triphenyltin hydroxide, mixtures thereof, their salts and N-oxides.

6. The composition according to claim 1, further comprising phosphoric acid ethoxylated alkyl ester compounds, methyl esters or fatty acid methyl esters, metal complexes, complexes of inorganic or organic compounds, aromatic hydrocarbons, unsaturated or saturated fatty acids, one or more basic compounds, one or more acids, solvents, salts, macro or micronutrients, diluents, organic or inorganic solids, antifoam agents, preservative agents, antioxidant agents, carrier agents, wetting agents, dispersant agents, solid carriers, suspending or anti-settling agents, absorption or adsorption aids, adhesive agents, surfactant agents, disintegrating agents, stabilizers, antifreezers, polymers or copolymers, mineral, vegetable, organosilicon oils, soluble or insoluble in water, organic or inorganic, or mixtures thereof, optionally at least one carrier agent, at least one wetting agent, at least one dispersing agent and at least one disintegrating agent, wherein these compounds are present in a concentration of 5 to 50% of the total weight of the composition.

7. A process for preparing a composition, which comprises at least one compound selected from the group of dinitriles or phthalamides and at least one compound selected from the group of azoles, comprising the steps of:
a1. reducing to a size of D₉₀ between 1 and 25 μm the particles of at least one compound selected from the group of dinitriles or phthalamides, their salts or N-oxides;
a2. separately reducing to a size of D₉₀ between 1 and 25 μm the particles of at least one compound selected from the group of azoles, their salts or N-oxides;
b. optionally drying the particles from steps a.1 and a.2 to a moisture content of not less than 2%;
c. aggregating by statics the particles of a.2 to the surface of the particles of a.1.

8. The process according to claim 7, wherein the particle size reduction occurs by dry granulation by disaggregation, wet granulation by disaggregation, wet granulation by aggregation.

9. The process according to claim 7, wherein the drying occurs by hot air drying, drying by direct contact with a hot surface, radiation drying and freeze drying, spray drying.

10. The process according to claim 7, wherein the aggregation of particles of at least one compound selected from the group of azoles to the surface of the particles of at least one compound selected from the group of dinitriles or phthalamides is by means of a spraying method.

11. The process according to claim 7, wherein the composition comprises at least one compound selected from the group of strobilurins, their salts or their N-oxides.

12. The process according to claim 11, wherein the particles of at least one compound selected from the group of strobilurins, their salts or N-oxides, are reduced to a size of D₉₀ between 1 and 25 μm in step a.1, together with at least one compound selected from the group of dinitriles or phthalamides, their salts or N-oxides.

13. The process according to claim 7, comprising the steps of:
a. adding at least one compound selected from the group of dinitriles or phthalamides, their salts and N-oxides, in solid form;
b. adding at least one dispersing agent, at least one wetting agent, at least one disintegrating agent and at least one carrier agent in solid form;
c.1. reducing particle size from step b. up to D₉₀ between 1 and 25 μm;
c.2. reducing the particle size of at least one compound selected from the group of azoles up to D₉₀ between 1 and 25 μm;
d. extruding and drying the mixture to a moisture content of not less than 2%;
e. aggregating by statics to the surface of the mixture from step d. at least one compound selected from the group of azoles from step c2.

14. The process according to claim 13, wherein after step c1, the mixture is wetted with 5% to 25% water.

15. The process according to claim 13, wherein the addition of steps a. and b. occur in a batch or continuous type mixer, Y, V, horizontal, ribbon mixers.

16. The process according to claim wherein steps a. to c1. occur separately or concomitantly.

17. The process according to claim 13, wherein steps c1. and c2. occur separately, in equipment with the same reduction mechanism or with different reduction mechanisms.

18. The process according to claim 13, wherein the particle reduction steps occur in an air jet crusher.

19. The process according to claim 13, wherein step d) of extrusion and drying occurs in a high or low pressure extruder, spraying, compacting, granulating by drum or rotating disc.

20. The process according to claim 13, wherein the particles of at least one compound selected from the group of strobilurins, their salts or N-oxides, are added in step a., together with at least one compound selected from the group of dinitriles or phthalamides, their salts or N-oxides.

21. The process according to claim 7, wherein said compound selected from the group of dinitriles or phthalamides is chlorothalonil, captan, folpet, their mixtures, their salts or their N-oxides, wherein these compounds are present in a range of 45% to 75% of the total weight of the composition.

22. The process according to claim 7, wherein said compound selected from the group of azoles is selected from the group consisting of prothioconazole, cyproconazole, tebuconazole, propiconazole, difenoconazole, hexaconazole, penconazole, ipconazole, metconazole, epoxiconazole, azaconazole, bitertanol, bromuconazole, diclobutrazol, difenoconazole, diniconazole, etaconazole, fenbuconazole, fluquinconazole, flusilazole, flutriafol, imibenconazole, myclobutanol, paclobutrazol, penconazole, simeconazole, tetraconazole, tridimefon, tridimenol and triticonazole, mixtures thereof, their salts and their N-oxides, wherein these compounds are present in a range of 0.5% to 7.5% of the total weight of the composition.

23. The process according to claim 11, wherein said compound from the group of strobilurins is selected from the group consisting of picoxystrobin, pyraclostrobin, azoxystrobin, trifloxystrobin, dimoxystrobin, famoxadone, fenamidone, fluoxastrobin, cresoxim-methyl, metaminostrobin, mixtures thereof, its salts and its N-oxides, wherein these compounds are present in a range of 0.5% to 5% of the total weight of the composition.

24. The process according to claim 7, wherein the compounds are in solid powder form.

25. The process according to claim 7, wherein the composition further comprises at least one additional compound selected from the group consisting of mancozeb, cupric fungicides, benomyl, methyl thiophanate, captafol, triphenyltin acetate, carbendazim, thiabendazole, copper oxychloride, copper sulfate, triphenyltin hydroxide, mixtures thereof, their salts and N-oxides.

26. The process according to claim 7, wherein the composition further comprises phosphoric acid ethoxylated alkyl ester compounds, methyl esters or fatty acid methyl esters, metal complexes, complexes of inorganic or organic compounds, aromatic hydrocarbons, unsaturated or saturated fatty acids, one or more basic compounds, one or more acids, solvents, salts, macro or micronutrients, diluents, organic or inorganic solids, antifoam agents, preservative agents, antioxidant agents, carrier agents, wetting agents, dispersant agents, solid carriers, suspending or anti-settling agents, absorption or adsorption aids, adhesive agents, surfactant agents, disintegrating agents, stabilizers, antifreezers, polymers or copolymers, mineral, vegetable, organosilicon oils, soluble or insoluble in water, organic or inorganic, or mixtures thereof, optionally at least one carrier agent, at least one wetting agent, at least one dispersing agent and at least one disintegrating agent, wherein these compounds are present in a concentration of 5 to 50% of the total weight of the composition.

27. A process for controlling the growth of agricultural pests, comprising applying the composition, as defined in claim 1, to the plants and/or their habitat, wherein the process comprises controlling rust, Plasmopara viticola, Elsinoe ampelina, Phomopsis viticola, Glomerella cingulata, Melanconium fuligineum, Isariopsis clavispora, Fusarium oxysporum f.sp. herbemontis and other agricultural pests, especially in crops of soybean, sorghum, cotton, rice, wheat, corn, oat, berries, fruits, leaf vegetables, legumes, vegetables, cereals, tubers, roots, bulbs, ornamental plants, trees and grasses, or any other crops that are affected by such undesirable pests.

28. A use of the composition as defined in claim 1, comprising a fungicide to eliminate or reduce the unwanted growth of agricultural pests on plants and/or their habitat.
